(19) United States
(12) Patent Application Publication
(10) Pub. No.: US 2011/0239114 A1
(43) Pub. Date: Sep. 29, 2011

(54) Apparatus and Method for Unified Experience Across Different Devices

(76) Inventors: David Robbins Falkenburg, San Jose, CA (US); Duncan Robert Kerr, San Francisco, CA (US); Michael J. Nugent, Monte Sereno, CA (US); Douglas Weber, Arcadia, CA (US)

(21) Appl. No.: 12/731,073

(22) Filed: Mar. 24, 2010

(51) Int. Cl. G06F 3/048

(52) U.S. Cl. 715/702; 715/863; 715/810

(57) ABSTRACT

Improved techniques for interacting with media content so as to provide a unified experience of media content across different devices are disclosed. A media content may be displayed on first display of the first device. A status of the media content may be communicated from the first device to a second device. The media content may be displayed on a second display of the second device, in accordance with the status of the media content from the first device.

### BACKGROUND OF THE INVENTION

1. Field of the Invention

The present invention relates to interacting with media content and, more particularly, to interacting with media content so as to provide a unified experience of the media content across different devices.

2. Description of the Related Art

Powered by recent advances in digital media technology, there is a rapid increase in variety of different ways of interacting with digital media content, such as images (e.g., photos), text, audio items (e.g., audio files, including music or songs), or videos (e.g., movies). In the past, consumers were constrained to interacting with digital media content on their desktop or in their living room of their home. Today, portability lets people enjoy digital media content at any time and in any place, using a variety of different media devices.

While portability of media content and availability of a variety of different media devices with different sizes, weights and capabilities offers many options to users, some challenges still remain. One difficulty is that interaction with media content across different devices may be tedious, difficult or confusing to some users. Further, while in any given set of circumstances, one device may be preferred over another, changing from one device to another tends to be difficult, confusing or inconvenient.

For example, while a full size device may provide a rich experience of a football game video at home, circumstances change when a viewer is interrupted with needing to leave home, for example, to catch a ride to the airport. Under such changed circumstances, a portable device would be needed to view the video. The user would need to provide the football game video to the portable device and thereafter start playback of the video while riding to the airport. Hence, a significant amount of care and effort is require for a user to change between devices.

Thus, there is a need for improved techniques for interacting with media content across different devices.

### SUMMARY OF THE INVENTION

Improved techniques are disclosed for interacting with media content so as to provide a unified experience of the media content across different devices. The media content may comprise digital media content, such as or images (e.g., photos), text, audio items (e.g., audio files, including music or songs), or videos (e.g., movies). One of the devices may comprise a handheld multifunction device capable of various media activities, such as playing or displaying each of images (e.g., photos), text, audio items (e.g., audio files, including music or songs), and videos (e.g., movies) in digital form. Another one of the devices may comprise a non-handheld base computing unit, which is also capable of such various media activities.

The invention can be implemented in numerous ways, including as a method, system, device, apparatus (including graphical user interface), or computer readable medium. Several embodiments of the invention are discussed below.

As a computer readable medium including at least computer program code stored therein for presenting media content on a display of another device, one embodiment includes at least: computer program code for displaying content on a display of a portable multifunction device; computer program code for detecting a predefined gesture with respect to the portable multifunction device; and computer program code for communicating a status of the portable multifunction device to a remote device in response to detection of the predefined gesture with respect to the portable multifunction device.

As a computer implemented method, one embodiment includes at least the acts of: displaying media content on a touch screen display of a portable multifunction device; communicating a status of the portable multifunction device to a remote device with a remote display; and displaying the media content on the remote display in response to a predefined gesture on the touch screen display.

As a computer implemented method, another embodiment includes at least the acts of: displaying media content on a remote display of a remote device; communicating a status of the remote device to a portable multifunction device with a touch screen display; and displaying the media content on the touch screen display in response to a predefined gesture on the touch screen display.

As a computer implemented method, yet another embodiment includes at least the acts of: providing a first device with a first display, and a second device with a second display; displaying media content on the first display of the first device; detecting a presence of the first device or the second device, or detecting a proximity of the first device and the second device; detecting a predefined gesture of a user; and displaying the media content on the second display in response to detecting the predefined gesture and detecting the presence or the proximity.

As computer readable medium including at least computer program code for managing display of media content on a first device with a first display, and a second device with a second display, one embodiment includes at least: computer program code for displaying media content on the first display of the first device; computer program code for detecting a presence of the first device or the second device, or detecting a proximity of the first device and the second device; computer program code for detecting a predefined gesture of a user; and computer program code for displaying the media content on the second display in response to detecting the predefined gesture and detecting the presence or the proximity.

As a computer system one embodiment includes at least: a first device hosting media content and having a first display; a first user interface for controlling display of the media content on the first display; a second device having a second display; at least one first sensor for sensing a predefined gesture of a user; at least one second sensor for sensing a presence of the first device or the second device, or for sensing a proximity of the first device and the second device; and control logic coupled with the first and second sensors and configured for facilitating display of the media content on the second display in response to detecting the predefined gesture and detecting the presence or the proximity.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a system for interacting with media content so as to provide a unified experience of the media content across different devices, according to one embodiment.

FIG. 2 illustrates a block diagram of several examples of sensors 150.

FIG. 3 is a flow diagram of a process for transferring status according to one embodiment.

FIG. 4 is a flow diagram of a process for displaying media content according to one embodiment.

FIG. 5 is a flow diagram of another process for displaying media content according to one embodiment.

FIG. 6 is a flow diagram of yet another process for displaying media content according to one embodiment.

FIG. 7 illustrates a simplified diagram of sensing presence or proximity.

FIG. 8 illustrates a simplified diagram of a unified experience of the media content across different devices.

FIG. 9 illustrates a simplified diagram similar to FIG. 8, but showing a predefined flicking touch gesture.

FIG. 10 illustrates a simplified diagram similar to FIG. 8, but showing a predefined multipoint touch gesture.

FIG. 11 illustrates a simplified diagram similar to FIG. 8, but showing a predefined shaking gesture.

FIG. 12 illustrates a simplified diagram similar to FIG. 8, but showing a predefined rolling gesture.

FIG. 13 illustrates a simplified diagram similar to FIG. 8, but showing a predefined throwing gesture.

FIG. 14 illustrates a simplified diagram similar to FIG. 8, but showing a predefined tapping gesture.

FIG. 15 is a simplified diagram of a second user interface substantially depicting a first device on a second display.

FIG. 16 is a simplified diagram of a second user interface depicting an animation on a second display.

### DETAILED DESCRIPTION OF EMBODIMENTS OF THE INVENTION

Improved techniques are disclosed for interacting with media content so as to provide a unified experience of the media content across different devices. The media content may comprise digital media content, such as or images (e.g., photos), text, audio items (e.g., audio files, including music or songs), or videos (e.g., movies). One of the devices may comprise a handheld multifunction device capable of various media activities, such as playing or displaying each of images (e.g., photos), text, audio items (e.g., audio files, including music or songs), and videos (e.g., movies) in digital form. Another one of the devices may comprise a non-handheld base computing unit, which is also capable of such various media activities.

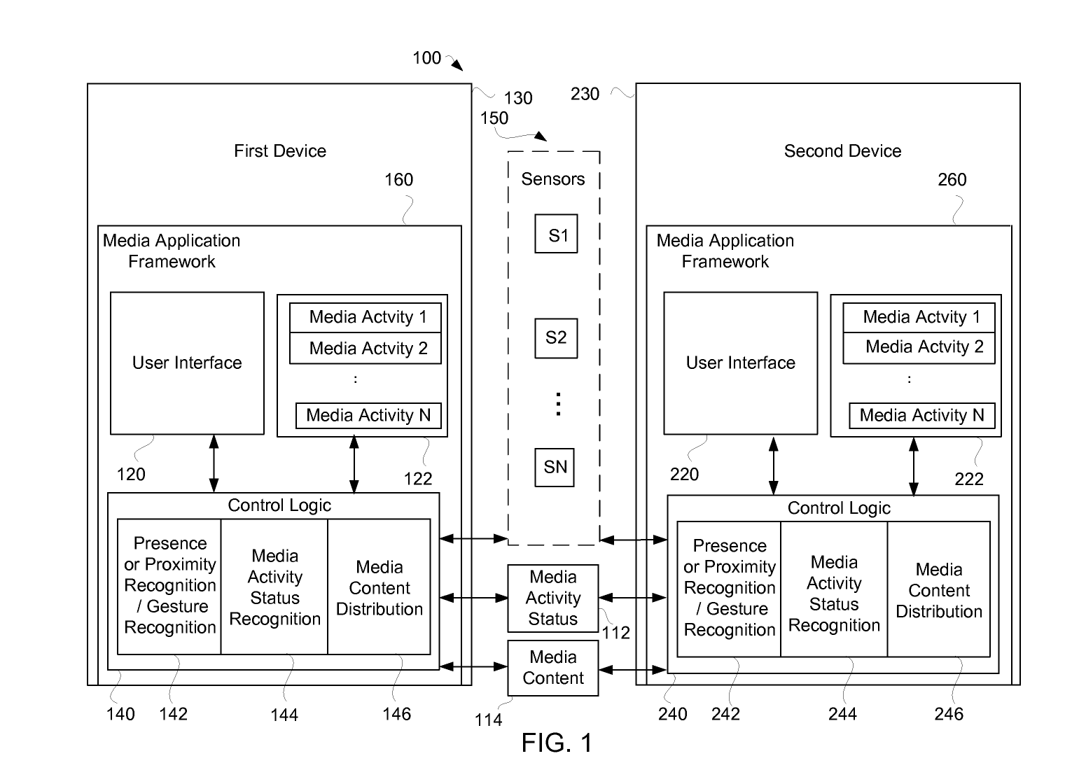

Embodiments of the invention are discussed below with reference to FIGS. 1-16. However, those skilled in the art will readily appreciate that the detailed description given herein with respect to these figures is for explanatory purposes, as the invention extends beyond these limited embodiments.

FIG. 1 is a block diagram of a system for interacting with media content so as to provide a unified experience of the media content across different devices, according to one embodiment. A user interface 120 may be coupled with a first device 130 for controlling operation of one or more of a plurality of media activities 122 of the first device 130. The first device 130 may comprise a portable electronic device, e.g., a the handheld multifunction device, capable of various media activities. In various different media activities of a user, the user may experience and manipulate media content in various different ways, or may experience and manipulate media content of different types or various combinations.

Control logic 140 of the first device 130 may utilize one or more of a plurality of sensors 150. Further, the control logic 140 of the first device 130 may be coupled with one or more of a plurality of sensors 150 for presence or proximity recognition and for gesture recognition (a presence or proximity recognition and gesture recognition component 142 of the control logic 140 of the first device 130 may be used), media activity status recognition (using a media activity status recognition component 144 of the control logic 140 of the first device 130) or media content distribution (using a media content distribution component 146 of the control logic 140 of the first device 130).

Similarly, a second user interface 220 may be coupled with a second device 230 for controlling operation of one or more of a plurality of media activities 222 of the second device 230. The second device may comprise a remote device. More specifically, the second device or remote device may comprise a non-handheld base computing unit, capable of various media activities. As examples, the second device can pertain to a desktop computer, a large display screen, a set-top box, or a portable computer. Control logic 240 of the second device 230 may utilize one or more of the plurality of sensors 150. Further, the control logic 240 of the second device 230 may be coupled with one or more of the plurality of sensors 150 for presence or proximity recognition and for gesture recognition (a presence or proximity recognition and gesture recognition component 242 of the control logic 240 of the second device 230 may be used), media activity status recognition (using a media activity status recognition component 244 of the control logic 240 of the second device 230) or media content distribution (using a media content distribution component 246 of the control logic 240 of the second device 230).

Media activity status 112 of media content displayed on one device may be sensed, and may be transferred to and recognized by the other device, so that the other device may display the media content according to the transferred media activity status 112. The media activity status 112 may comprise status of progress of the one device in playing media content, which may be sensed and may be transferred to and recognized by the other device, so that other device may play the media content according to such progress. For example, such media activity status 112 may comprise current status of progress of playing a particular video. For example, the first device 130 may have played the particular video up to an event (e.g., a touchdown event). Such progress may be sensed and may be transferred to and recognized by the second device 230, so that the second device 130 may continue playing the particular video according to such progress, at the point of the event. The foregoing may provide a unified experience of the media content across different devices, wherein the first and second devices 130, 230 may be different devices.

In particular, the plurality of sensors 150 may comprise a software sensor for sensing the media activity status of media content displayed on the first device 130. The media activity status of the first device 130 may be sensed by the software sensor, and may be transferred and recognized using the media activity status recognition component 244 of the control logic 240 of the second device 230, so that the second device 230 may display the media content according to the transferred media activity status 112.

Similarly, the plurality of sensors 150 may further comprise a software sensor for sensing the media activity status of media content displayed on the second device 230. The media activity status of the second device 230 may be sensed by the software sensor, and may be transferred and recognized using the media activity status recognition component 144 of the control logic 140 of the first device 130, so that the first device 130 may display the media content according to the transferred media activity status 112.

Further, the plurality of sensors 150 may comprise one or more software sensors S1, S2, . . . , SN for sensing presence of media content stored in long term memory of the first device 130, and/or may comprise one or more software sensors S1, S2, . . . , SN for sensing presence of media content stored in long term memory of the second device 230. If the software sensors sense that media content stored in the first device 130 is not already stored in the second device 230 (i.e. is absent), then media content 114 may be distributed to the second device 230 using the media content distribution component 146 of the control logic 140 of the first device 130, so that the second device 230 may display the media content 114.

Similarly, if the software sensors sense that media content stored in the second device 230 is not already stored in the first device 130 (i.e., is absent), then media content 114 may be distributed to the first device 130 using the media content distribution component 246 of the control logic 240 of the second device 230, so that the first device 130 may display the media content 114.

In one embodiment, the plurality of sensors 150 may comprise one or more software sensors for sensing media content shown in an active window display of the user interface 120 of the first device 130, and may comprise one or more software sensors for sensing media content shown in an active window display of the user interface 220 of the second device 230. The control logic 140 may be configured for transferring to the second device 230 the media content shown in the active window display of the first device 130. The control logic 240 may be configured for transferring to the first device 130 the media content shown in the active window display of the second device 230.

In light of the foregoing, it should be understood that the control logic 140 may be configured for automatically determining the media content for transfer to the second device 230, and transferring the media content to the second device 230 (or may be configured for automatically determining the media content for transfer to the first device, and transferring the media content to the first device). Media content may be distributed wirelessly, using wireless communication electronics. For example, near field communication electronics or Bluetooth™ electronics or WiFi networking electronics may be used.

In discussions of the control logic 140 of the first device 130 and of the control logic 240 of the second device 230, as well as discussions of any other logics herein, it should be understood that “logic”, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software or software components. Where multiple logical logics are described, it may be possible to incorporate the multiple logical logics into one physical logic.

Further, a media application framework 160 of the first device 130 may be employed provide media application services and/or functionality to the plurality of media activities 122 of the first device 130. The media application framework 160 of the first device 130 may control the plurality of media activities 122 of the first device 130. Similarly, a media application framework 260 of the second device 230 may be employed to provide media application services and/or functionality to the plurality of media activities 222 of the second device 230. The media application framework 260 of the second device 230 may control the plurality of media activities 222 of the second device 230. As shown in FIG. 1, the media application frameworks 160, 260 of the first and second devices 130, 230 may be coupled with the plurality of sensors 150 for providing the unified experience of the media content across different devices, wherein the first and second devices 130, 230 may be different devices (e.g., different types of devices).

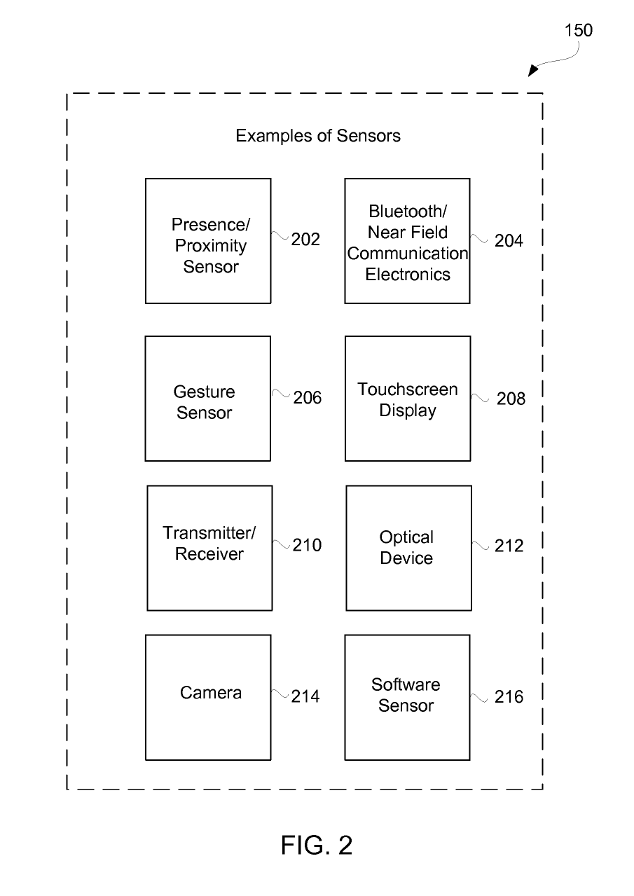

FIG. 2 illustrates a block diagram of several examples of sensors 150. The device 130, 230 may comprise one or more of the exemplary sensors shown in FIG. 2. The exemplary sensors can be used separately or in combination. The plurality of sensors 150 may comprise a presence or proximity sensor 202. The plurality of sensors 150 may also comprise Bluetooth™ or near field communication electronics 204. Further, the plurality of sensors 150 may comprise a gesture sensor 206, such as an accelerometer and/or position sensor for sensing a device gesture made by the user moving the handheld multifunction device. The gesture sensor 206 may comprise a touch gesture sensor for sensing a user touching the handheld multifunction device or the non-handheld base computing unit, or a touch screen display 208 may be employed. Additionally, the plurality of sensors 150 may comprise a wired or wireless transmitter and/or receiver 210, an optical device 212, or a camera 214. Examples of the camera 214 are a webcam, a digital camera or a digital video camera.

The plurality of sensors 150 may comprise a software sensor 216 or a plurality of software sensors for sensing media content or media activity status. One or more of the devices may have displayed one or more active windows that highlight particular media content (e.g., a photograph from a photograph library, a photograph that was taken by a device camera or camera functionality, or an audio or video track). One or more software sensors may sense particular or highlighted media content, or may sense media content within an active window.

Further, the plurality of sensors may comprise a software sensor for sensing the media activity status in an active display window of the media activity. In particular, the software sensor may sense media activity status of progress of the media activity of playing media content in an active display window of one device, so that the media activity status can be transferred to the other device. The other device may continue playing the media content in an active window of the other device, according to the transferred media activity status. One or more of any of the foregoing software sensors may sense commands, or machine state, or may be of a trap type for manipulating data and making operations on known variables.

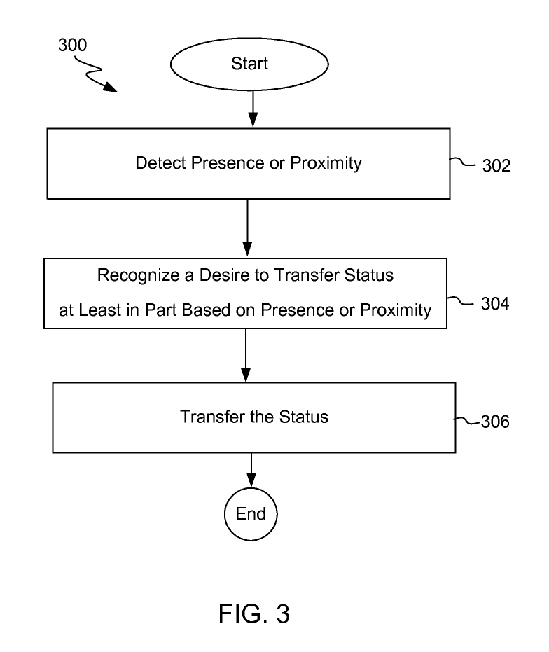

FIG. 3 is a flow diagram of a process 300 for transferring status from one device to another device according to one embodiment. One device may be the first device such as a handheld multifunction device, and the status may be media activity status of progress of a media activity of playing media content in an active display window of such device. The other device may be a second device such as non-handheld base computing unit, so that the media activity status can be transferred to such other device. Alternatively, the transfer of status may be to the handheld multifunction device from the non-handheld base computing unit. For example, the media activity status may be media activity status of progress of a media activity of playing media content in an active display window of the non-handheld base computing unit, and the media activity status may be transferred to the handheld multifunction device.

The process 300 may begin with detecting 302 presence of one device or the other device, or proximity of the one device relative to the other device. In one embodiment, the presence or proximity can be detected using one or more suitable sensors of the plurality of sensors 150. The process 300 may continue with recognizing 302 a desire to transfer status (e.g., media activity status) from one device to the other device, at least in part based on proximity of the two devices, or on presence of one device or the other device 304. A transmission handshake (or a wireless transmission handshake) may be initiated between one device and the other device, upon recognizing the desire to transfer status.

The process may continue with transferring 306 the status (e.g., media activity status) from the first device to the second device. The process 300 can then end. The status may be transferred using wireless communication. For example, near field communication electronics, Bluetooth™ electronics or WiFi networking electronics may be used.

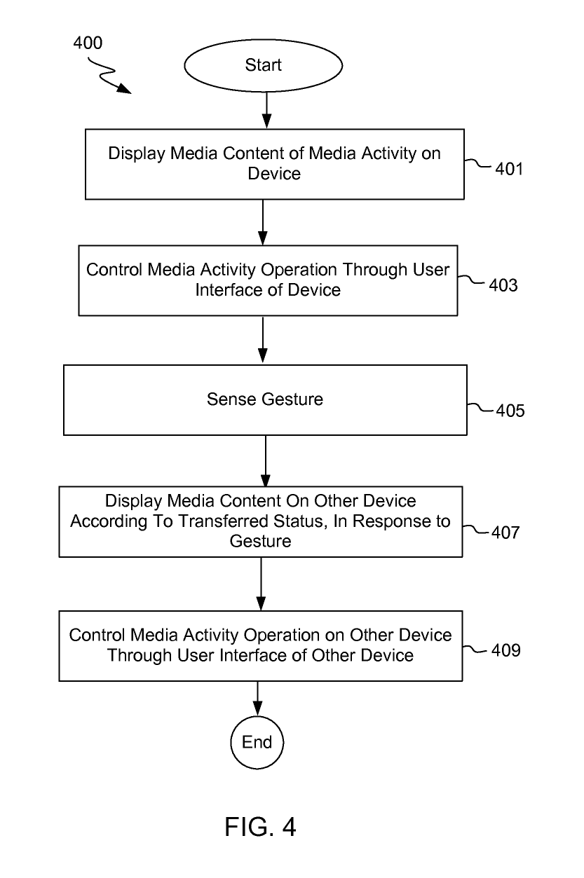

FIG. 4 is a flow diagram of a process 400 for displaying media content according to one embodiment. The process 400 may begin with displaying 401 media content of a media activity on a device. The process 400 may continue with controlling 403 media activity operation through a user interface of the device. The process 400 may continue with sensing 405 a predefined gesture of a user. The process 400 may continue with displaying 407 the media content on an other device according to a transferred media activity status, in response to the predefined gesture. Media activity status may be transferred according to the process 300 discussed previously herein with respect to FIG. 3. The process 400 may continue with controlling 409 media activity operation on the other device, through a user interface of the other device. After the media activity operation is controlled 409, the process 400 can end.

For example, the process 400 may be employed by displaying 401 media content of a media activity on a touch screen display of a handheld multifunction device. The process 400 may continue with controlling 403 media activity operation through a user interface of the handheld multifunction device. The process 400 may continue with sensing 405 a predefined gesture of a user on the touch screen display of the handheld multifunction device. The process 400 may continue with displaying 407 the media content on a remote display of a remote device according to the transferred media activity status, in response to the predefined gesture. For example, the remote device may be the non-handheld base computing unit. The process 400 may continue with controlling 409 media activity operation on the remote device, through a user interface of the remote device 409.

As another example, the process 400 may be employed by displaying 401 media content of a media activity on a remote display of a remote device. The process 400 may continue with controlling 408 media activity operation through a user interface of the remote device. The process 400 may continue with sensing 405 a predefined gesture of a user on a touch screen display of a handheld multifunction device. The process 400 may continue with displaying 407 the media content on the touch screen display of the handheld multifunction device according to the transferred media activity status, in response to the predefined gesture. The process 400 may continue with controlling 409 media activity operation on the handheld multifunction device, through the user interface of the handheld multifunction device.

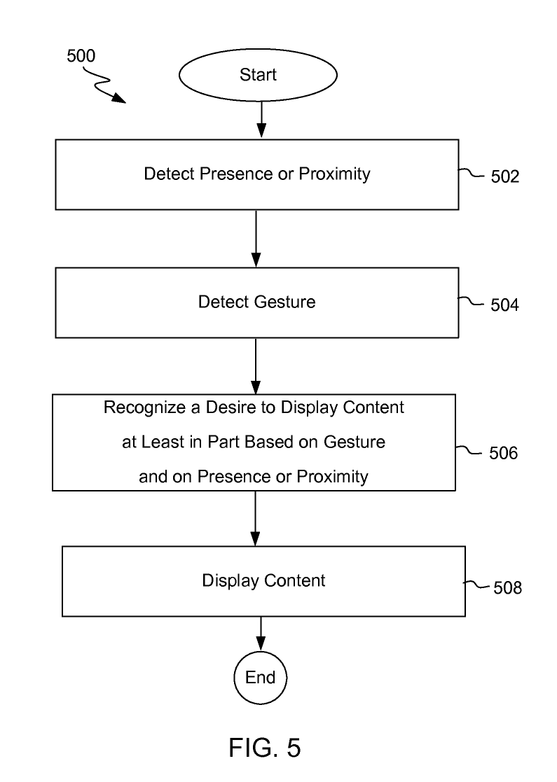

FIG. 5 is a flow diagram of another process 500 for displaying media content according to one embodiment. One device may be the first device such as a handheld multifunction device, and media content may be initially displayed in an active display window of such device. An other device may be the second device such as a non-handheld base computing unit, so that the media content can be displayed subsequently on such other device.

The process 500 may begin with detecting 502 presence or proximity. For example, presence of one device or the other device, or proximity 502 of the one device relative to the other device can use one or more suitable sensors, of the plurality of sensors 150. The process 500 may continue with detecting 504 a predefined gesture of a user. The process 500 may continue with recognizing 506 a desire to display content on the other device, at least in part based on the predefined gesture and on the presence or proximity. The process 500 may continue with displaying 508 the media content on the other device 508. After displaying 508 the media content, the process 500 can end.

In an alternative embodiment of the process 500 for displaying media content, the handheld multifunction device may be the other device, and the non-handheld base computing unit may be the one device. In this embodiment, the media content may be displayed initially in an active display window of the non-handheld base computing unit, so that the media content can be displayed subsequently on the handheld multifunction device, as the other device.

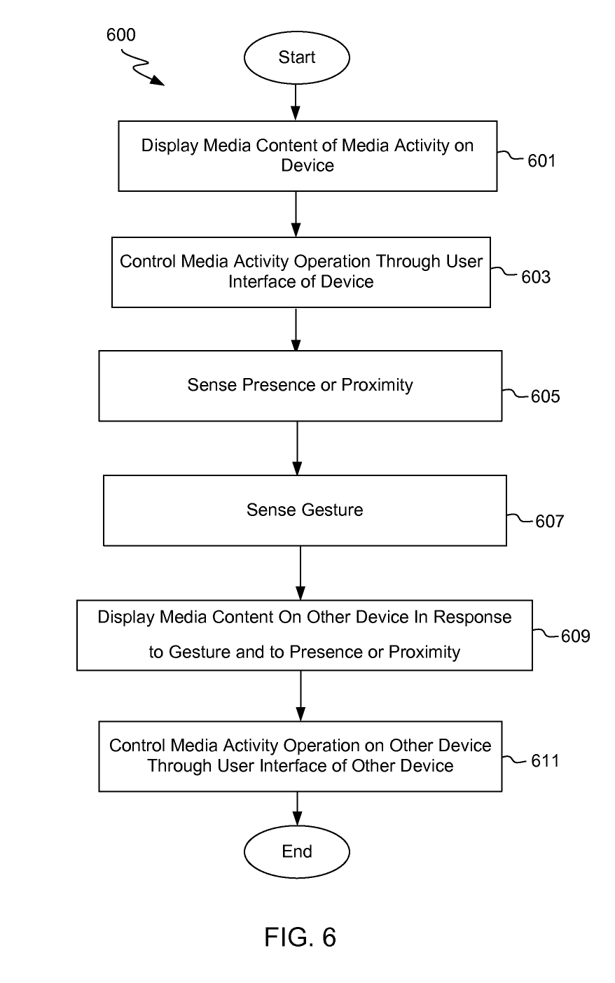

FIG. 6 is a flow diagram of yet another process 600 for displaying media content according to one embodiment. The process 600 may begin with displaying 601 media content of a media activity on a device 601. The process 600 may continue with controlling 603 media activity operation through a user interface of the device. The process 600 may continue with sensing 605 presence or proximity. For example, the presence of one device or the other device, or proximity of the one device relative to the other device can use one or more suitable sensors, of the plurality of sensors 150. The process 600 may continue with sensing 607 a predefined gesture of a user. The process 600 may continue with displaying 609 the media content on an other device in response to the predefined gesture and the presence or proximity. The process 600 may continue with controlling 611 media activity operation on the other device, through a user interface of the other device. After controlling 611 the media activity operation, the process 600 can end.

For example, the process 600 may be employed by displaying 601 media content of a media activity on a touch screen display of a handheld multifunction device. The process 600 may continue with controlling 603 media activity operation through a user interface of the handheld multifunction device. The process 600 may continue with sensing 605 presence of the handheld multifunction device or a remote device (such as a non-handheld base computing unit), or proximity of the handheld multifunction device relative to the remote device. The process 600 may continue with sensing 607 a predefined gesture of a user on the touch screen display of the handheld multifunction device. The process 600 may continue with displaying 609 the media content on the remote display of the remote device, in response to the predefined gesture and to the presence or proximity. The process 600 may continue with controlling 611 media activity operation on the remote device, through a user interface of the remote device. Thereafter the process 600 can end.

As another example, the process 600 may be employed by displaying 601 media content of a media activity on a remote display of a remote device. The process 600 may continue with controlling 603 media activity operation through the user interface of the remote device. The process 600 may continue with sensing 605 presence of a handheld multifunction device or the remote device (such as the non-handheld base computing unit), or proximity of the handheld multifunction device relative to the non-handheld base computing unit. The process 600 may continue with sensing 607 a predefined gesture of a user on the touch screen display of the handheld multifunction device. The process 600 may continue with displaying 609 the media content on the touch screen display of the handheld multifunction device, in response to the predefined gesture and to the presence or proximity. The process 600 may continue with controlling 611 media activity operation on the handheld multifunction device, through the user interface of the handheld multifunction device 609. Thereafter, the process 600 can end.

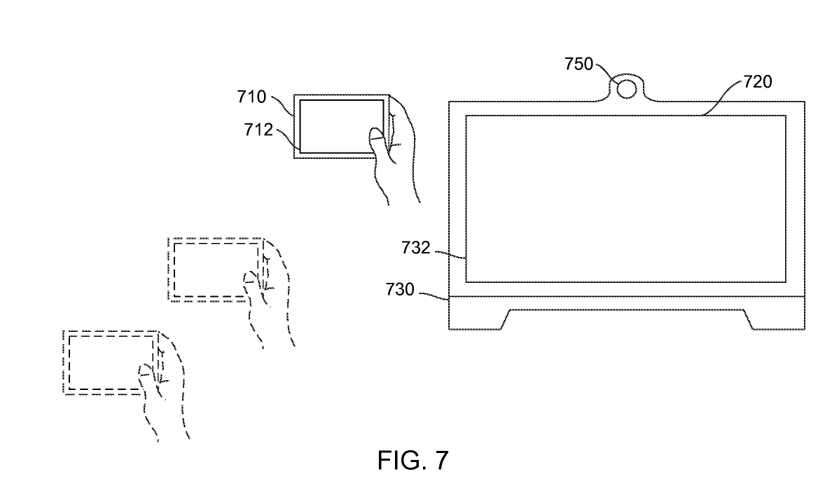

FIG. 7 illustrates a simplified diagram of sensing presence or proximity. The first device shown in FIG. 7 may comprise a handheld multifunction device 710 having an associated touch screen display 712 capable of playing/displaying images (e.g., photos), text, audio items (e.g., audio files, including music or songs), and/or videos (e.g., movies) in digital form, as discussed previously herein. The second device shown in FIG. 7 may comprise the remote device 730 with its associated remote display 732, as discussed previously herein, and more particularly may comprise a non-handheld base computing unit with its associated display, which is capable of the various media activities.

One or more sensors 750 may sense presence of the handheld multifunction device 710, or may sense proximity of the handheld multifunction device 710 relative to the remote device 730. Although one or more of the sensors 750 are shown in FIG. 7 as remote from the handheld multifunction device 710 and integral with remote device 730 and the remote display 732, it should be understood that arrangement of the sensors is not necessarily limited to the arrangement specifically shown in FIG. 7. For example, one or more of the sensors (or portions thereof) may be otherwise disposed, for example, on or in the handheld multifunction device (e.g., on or in a housing of the handheld multifunction device).

As shown in FIG. 7 the handheld multifunction device 710 may be movable to alternative positions. A proximate position of the handheld multifunction device 710 is depicted in solid line in FIG. 7. Alternative distal positions of the handheld multifunction device are depicted in dashed lines in FIG. 7.

As the handheld multifunction device 710 may be moved by a user through alternative positions, from the distal positions to the proximate position, the handheld multifunction device 710 may cross a preselected presence or proximity threshold of a presence or proximity recognition component of control logic. Upon crossing such presence or proximity threshold, the presence or proximity recognition component of the control logic may detect the presence or proximity.

A user interface may comprise a notification for notifying the user upon the handheld multifunction device crossing the presence or proximity threshold. Further, the user interface may comprise a notification for notifying the user upon the control logic transferring media activity status. For example, the notification can be visual (e.g., displayed notification) or audio (e.g., sound notification).

As another example, the user interface may comprise a haptic notification for notifying the user. More particularly, a haptic device may be disposed in or on the handheld multifunction device 710 (or in or on the housing of the handheld multifunction device 710). The haptic device may be in operative communication with, and activated by, the user interface, so that the user's hand (shown holding the handheld multifunction device 710 in FIG. 7) feels a haptic sensation from the haptic notification.

The proximate position of the handheld multifunction device 710 may be understood as proximate relative to the non-handheld base computing unit 730. Accordingly, the one or more sensors 750 may comprise a proximity sensor for sensing proximity of the handheld multifunction device 710 and the non-handheld base unit 730. Similarly, it should be understood that although the one or more sensors 750 may be broadly referenced herein, proximity may be particularly sensed by one or more of near field communication electronics, piconet (e.g., Bluetooth™) electronics, an optical device, a camera (such as a webcam, a digital camera or a digital video camera), a touch screen display, an accelerometer, or a wireless transmitter and/or receiver. Notwithstanding the foregoing description of functionality for sensing presence or proximity, it should be understood the foregoing may convey, transfer or distribute media activity status and/or media content.

In response to the one or more sensors 750 and the presence or proximate position of the handheld multifunction device 710 relative to the non-handheld base computing unit 730, one or more presence or proximity recognition components of one or more control logics may detect the presence or proximity of the handheld multifunction device 710 or/and the non-handheld base computing unit 730. Upon detecting the presence or proximity of the handheld multifunction device 710 or/and the non-handheld base computing unit 730, the media activity status can be transferred.

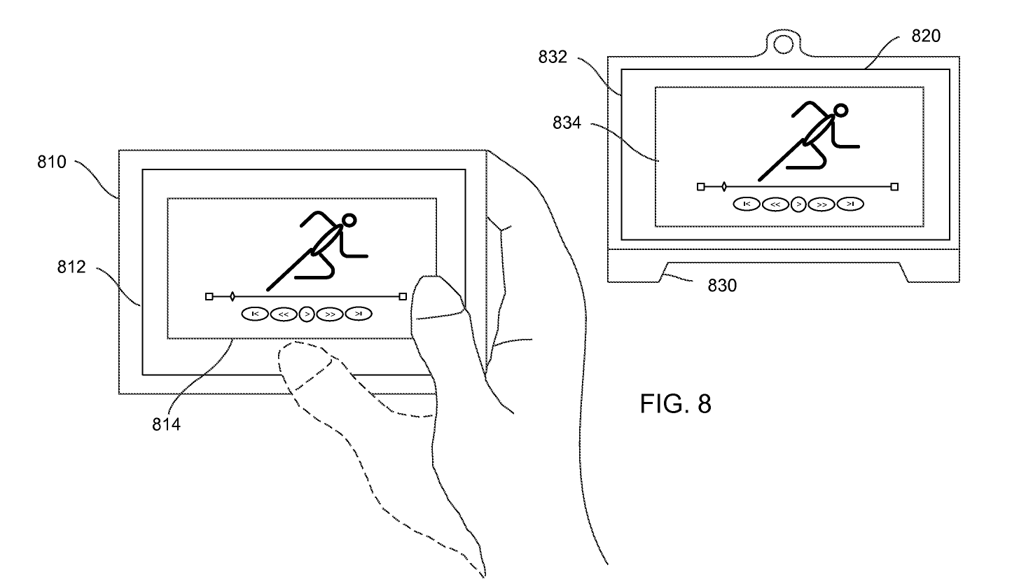

FIG. 8 illustrates a simplified diagram of a unified experience of the media content across different devices. As shown in FIG. 8 media content of a media activity may be displayed in an active window on one of the devices. Media activity operation may be controlled through a user interface of the device. A predefined gesture of a user may be sensed. Media content may be displayed on another device according to a transferred media activity status, in response to the predefined gesture. For example, media activity status may be transferred according to any of the processes discussed previously herein. Media activity operation on the other device may be controlled through a user interface of the other device. Alternatively, media activity operation on the other device could be remotely controlled from the device.

For example, the first device shown FIG. 8 may comprise a handheld multifunction device 810 having a touch screen display 812, which may be employed for displaying media content 814 of a media activity in an active window. For example, the media activity may be playing a video on the touch screen display 812. Operation of the media activity (e.g., playing the video) may be controlled through a user interface of the handheld multifunction device 810. FIG. 8 shows at least a portion of the user interface, which is for playback control for the playing of the video on the handheld device 810 (i.e., display of selectable controls: “|<” for advance to beginning; “<<” for advance back; “>” for play; “>>” for advance forward; and “>|” for advance to end).

Further, in FIG. 8 the user interface of the handheld multifunction device 810 may indicate at least a portion of the media activity status, by showing a display of a video slider bar having a longitudinal dimension, and by showing a diamond figure disposed at a location along the longitudinal dimension, for indicating status of progress of the handheld multifunction device in playing the video. For example, such media activity status may comprise current status of progress of playing the video. For example, the video can be a football game video and the current status of progress can be to a point of a touchdown event. As discussed previously herein, such progress may be sensed as at least a portion of the media activity status, and may be transferred and recognized by the other device, so that the other device may continue playing the video according to such progress. For example, the other device can continue the video playback in accordance with the current status of progress. For example, when the video is a football game video, the football game video can continue video playback on the other device according to such progress, i.e., at the point of the touchdown event.

FIG. 8 depicts a predefined swiping touch gesture of a user's thumb on the touch screen display of the handheld multifunction device 810, wherein the user's thumb moves through alternative positions, from a distal position to a proximate position. In the predefined swiping touch gesture shown in FIG. 8, the distal position of the user's thumb is shown in dashed line, while the proximate position of the user's thumb is shown in solid line.

As the user's thumb moves through alternative positions of the predefined swiping touch gesture, from the distal position to the proximate position on the touch screen display 812, the predefined swiping touch gesture may be sensed by touch sensing components of the touch screen display 812, and may substantially match a predefined swiping gesture data template of a gesture recognition component of control logic. Upon substantially matching the predefined swiping gesture data template, the gesture recognition component of the control logic may detect the predefined swiping touch gesture.

The second device shown in FIG. 8 may comprise a remote device 830 with its associated remote display 832. As discussed previously herein, the remote device 830 may comprise a non-handheld base computing unit 830 with its associated display 832, which is capable of the various media activities. As shown in FIG. 8, media content 834 may be displayed on the remote display 832 of the remote device 830 according to the transferred media activity status, in response to sensing and detecting the predefined gesture. For example, as shown in FIG. 8, in the user interface of the remote device 830, a display of a video slider bar is shown having a longitudinal dimension, and a diamond figure is disposed at a location along the longitudinal dimension, for indicating status of progress of the remote device 830 in playing the video.

Operation of the media activity (e.g., playing the video) may be controlled through the user interface of the remote device 830. FIG. 8 shows at least a portion of the user interface, which is for controlling playback of the video on the remote device 830 (i.e., display of selectable controls: “|<” for advance to beginning; “<<” for advance back; “>” for play; “>>” for advance forward; and “>|” for advance to end).

As another example, operation as just discussed may be reversed with respect to the handheld multifunction device 810 and the remote device 830. Specifically, media content 834 of a media activity may be displayed initially in an active window on the remote display 832 of the remote device 830. Operation of the media activity (e.g., playing the video) on the remote device 830 may be controlled through the user interface of the remote device 830. The media content 814 may be displayed subsequently on the touch screen display 812 of the handheld multifunction device 810, according to the transferred media activity status, and in response to sensing and detecting the user's predefined gesture on the touch screen display 812. Operation of the media activity (e.g., playing the video) on the handheld multifunction device 810 may be controlled through the user interface of the handheld multifunction device 810. Alternatively, media activity operation on the other device could be remotely controlled from the device.

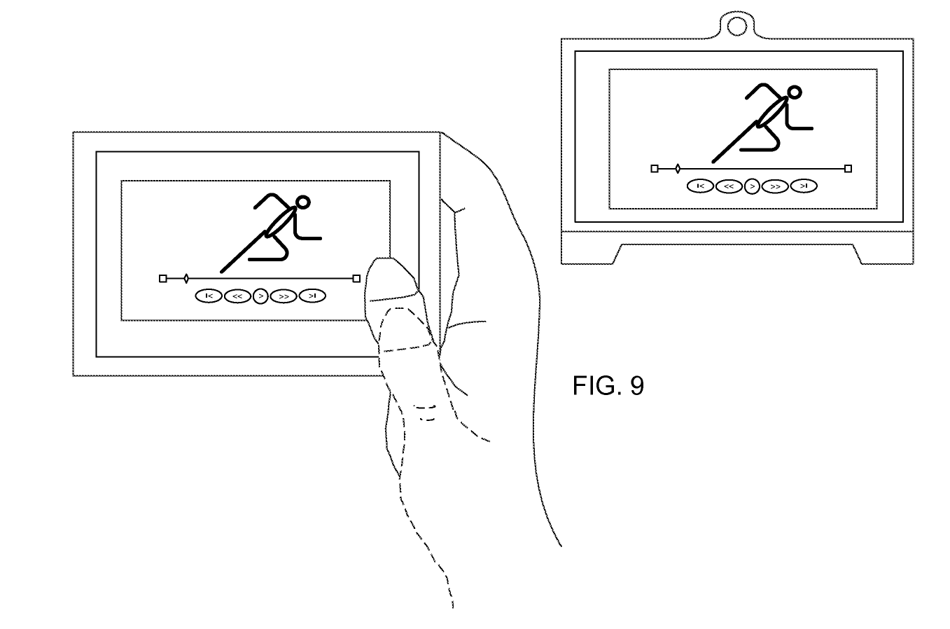

FIG. 9 illustrates a simplified diagram similar what was just discussed with respect to FIG. 8, but showing a predefined flicking touch gesture, in place of the predefined swiping gesture of FIG. 8. FIG. 9 depicts the predefined flicking touch gesture of a user's thumb on the touch screen display of the handheld multifunction device, wherein the user's thumb moves through alternative positions, from a contracted position to an extended position. In the predefined flicking gesture shown in FIG. 9, the contracted position of the user's thumb is shown in dashed line, while the extended position of the user's thumb is shown in solid line.

As the user's thumb moves through alternative positions of the predefined flicking touch gesture, from the contracted position to the extended position on the touch screen display, the predefined flicking touch gesture may be sensed by touch sensing components of the touch screen display, and may substantially match a predefined flicking gesture data template of a gesture recognition component of control logic. Upon substantially matching the predefined flicking gesture data template, the gesture recognition component of the control logic may detect the predefined flicking touch gesture.

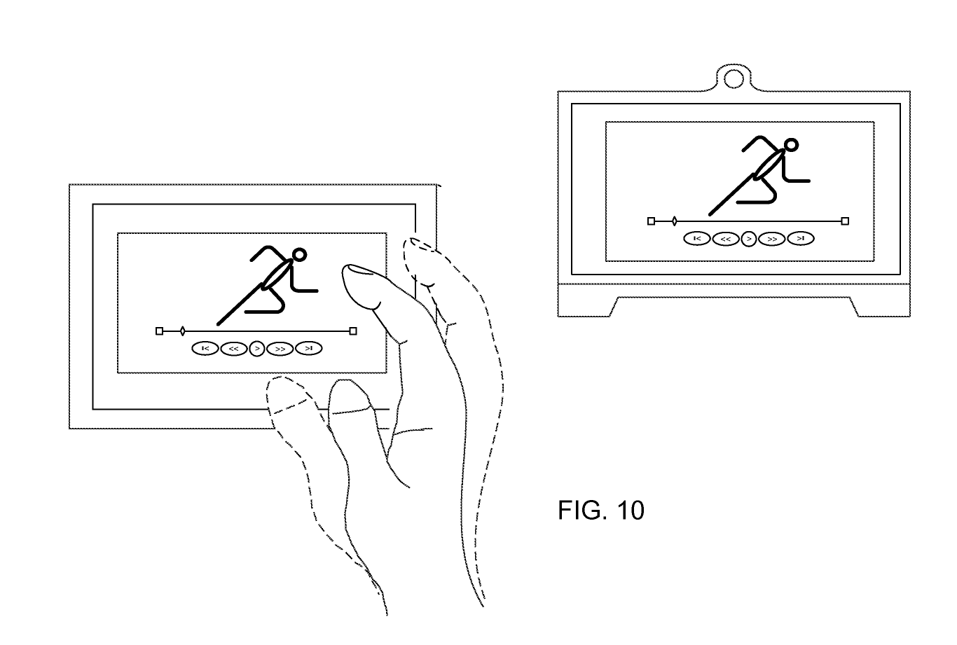

FIG. 10 illustrates a simplified diagram similar what was just discussed with respect to FIG. 8, but showing a predefined multipoint touch gesture, in place of the predefined swiping gesture of FIG. 8. FIG. 10 depicts the predefined multipoint touch gesture of a user's thumb and forefinger on the touch screen display of the handheld multifunction device, wherein the user's thumb and forefinger move through alternative positions, from distal spread positions to proximate pinching positions. In the predefined multipoint touch gesture shown in FIG. 10, the distal spread positions of the user's thumb and forefinger are shown in dashed line, while the proximate pinching position of the user's thumb and forefinger are shown in solid line.

As the user's thumb and forefinger move through alternative positions of the predefined multipoint touch gesture, from distal spread positions to the proximate pinching position on the touch screen display, the predefined multipoint touch gesture may be sensed by touch sensing components of the touch screen display, and may substantially match a predefined multipoint gesture data template of the gesture recognition component of the control logic. Upon substantially matching the predefined multipoint gesture data template, the gesture recognition component of the control logic may detect the predefined multipoint touch gesture.

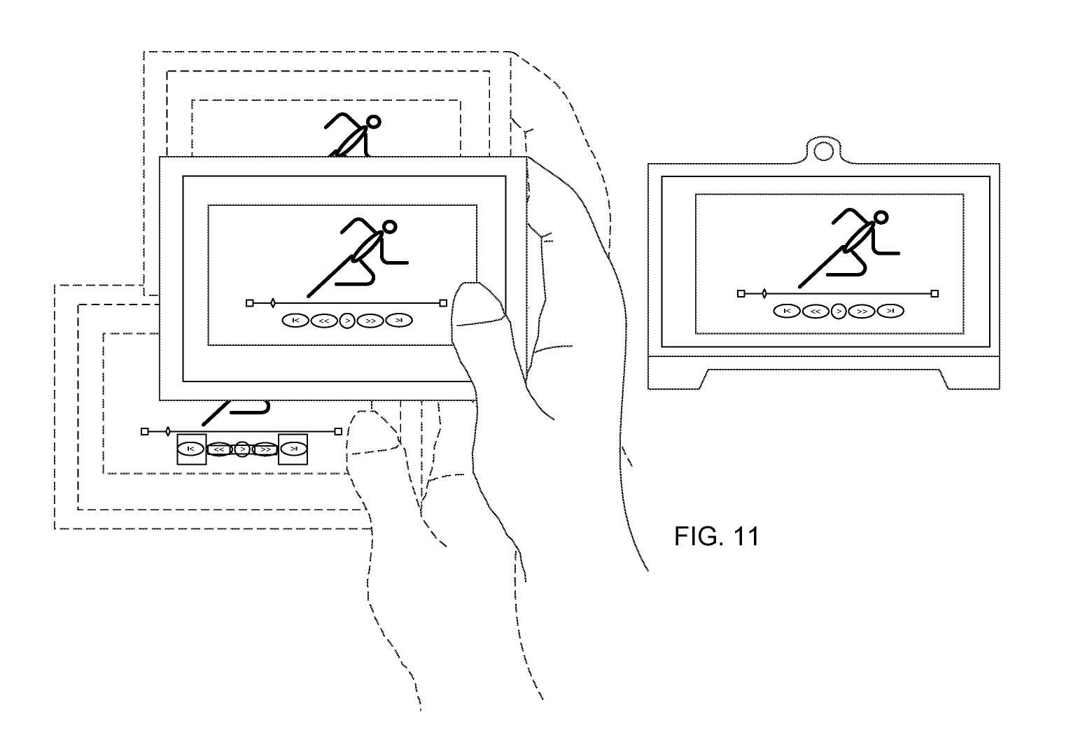

FIG. 11 illustrates a simplified diagram similar to what was just discussed with respect to FIG. 8, but showing a predefined shaking gesture in place of the predefined swiping gesture of FIG. 8. FIG. 11 depicts a device gesture, which is made by the user moving the handheld multifunction device through alternative positions of the predefined shaking gesture to a resting position. In the predefined shaking gesture shown in FIG. 11, alternative positions are shown in dashed line, while the resting position is shown in solid line.

As the user moves the handheld multifunction device through alternative positions of the predefined shaking gesture to the resting position, the predefined shaking gesture may be sensed by the gesture sensor (for example one or more accelerometers), and may substantially match a predefined shaking gesture data template of a gesture recognition component of control logic. Upon substantially matching the predefined shaking gesture data template, the gesture recognition component of the control logic may detect the predefined shaking gesture.

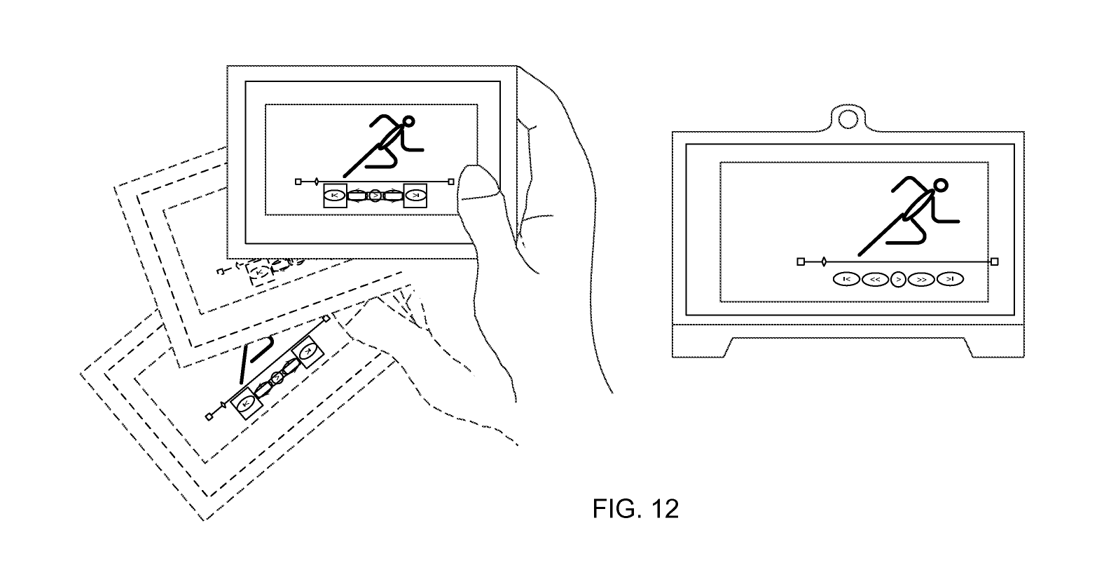

FIG. 12 illustrates a simplified diagram similar to what was just discussed with respect to FIG. 8, but showing a predefined rolling gesture in place of the predefined swiping gesture of FIG. 8. FIG. 12 depicts a device gesture, which is made by the user rotating the handheld multifunction device through alternative positions of the predefined rolling gesture to a rotated position. In the predefined rolling gesture shown in FIG. 12, alternative positions are shown in dashed line, while the rotated position is shown in solid line.

As the user moves the handheld multifunction device through alternative positions of the predefined shaking gesture to the rotated position, the predefined rolling gesture may be sensed by the gesture sensor (for example one or more accelerometers), and may substantially match a predefined rolling gesture data template of a gesture recognition component of control logic. Upon substantially matching the predefined rolling gesture data template, the gesture recognition component of the control logic may detect the predefined rolling gesture.

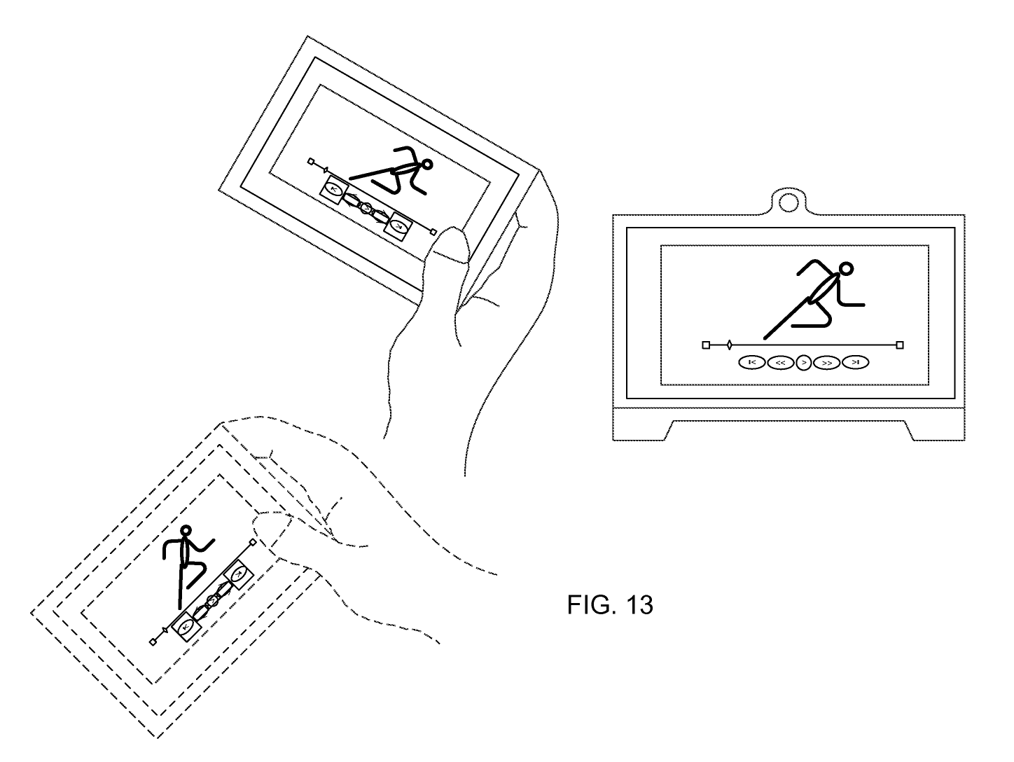

FIG. 13 illustrates a simplified diagram similar to what was just discussed with respect to FIG. 8, but showing a predefined throwing gesture in place of the predefined swiping gesture of FIG. 8. FIG. 13 depicts a device gesture, which is made by the user extending the handheld multifunction device through alternative positions of the predefined throwing gesture to an extended position. In the predefined throwing gesture shown in FIG. 13, an alternative withdrawn position is shown in dashed line, while the extended position is shown in solid line.

As the user moves the handheld multifunction device through alternative positions of the predefined throwing gesture to the extended position, the predefined throwing gesture may be sensed by the gesture sensor (for example one or more accelerometers), and may substantially match a predefined throwing gesture data template of a gesture recognition component of control logic. Upon substantially matching the predefined throwing gesture data template, the gesture recognition component of the control logic may detect the predefined throwing gesture.

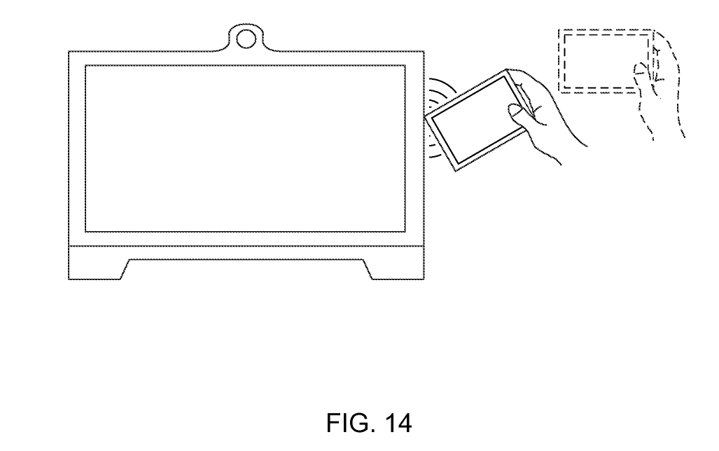

FIG. 14 illustrates a simplified diagram similar to what was just discussed with respect to FIG. 8, but showing a predefined tap gesture in place of the predefined swiping gesture of FIG. 8. FIG. 14 depicts a device gesture, which is made by the user moving the handheld multifunction device through alternative positions of the predefined tap gesture to an impact position. In the predefined tap gesture shown in FIG. 14, an alternative position is shown in dashed line, while the impact position is shown in solid line. Of course, invisible vibrational waves may accompany impact of the handheld multifunction device in the impact position of the tap gesture. For purposes of illustration, such invisible vibrational waves are depicted in FIG. 14 as concentric arcs.

As the user moves the handheld multifunction device through alternative positions of the predefined tap gesture to the impact position, the predefined tap gesture may be sensed by a gesture sensor (for example one or more accelerometers), and may substantially match a predefined tapping gesture data template of a gesture recognition component of control logic. Upon substantially matching the predefined tap gesture data template, the gesture recognition component of the control logic may detect the predefined tap gesture. In one embodiment, because there is an impact, either or both of a gesture sensor at the handheld multifunction device and a gesture sensor at the remote device can sense the tap gesture. The tap gesture can also serve to identify the other device. Still further, the tap gesture can authorization a wireless data exchange therebetween.

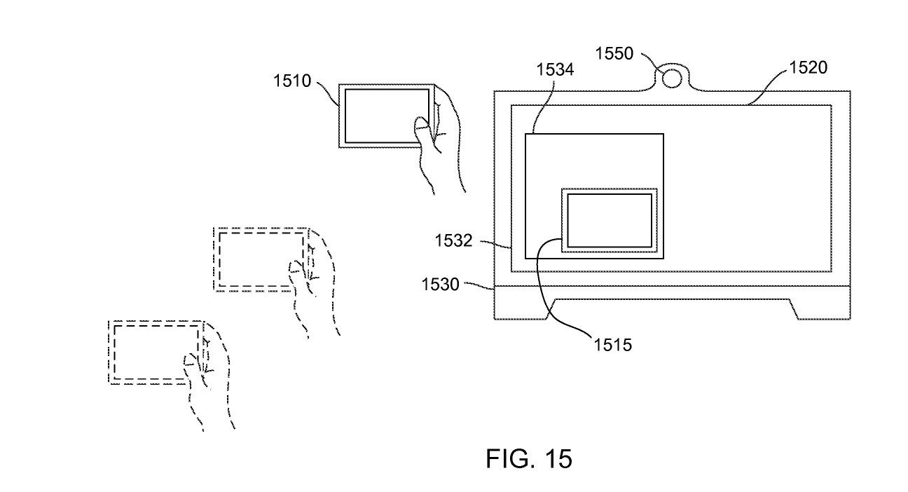

FIG. 15 is a simplified diagram of a second user interface substantially depicting a first device on a second display. As shown in FIG. 15, a first device 1510 may comprise a handheld multifunction device 1510 having an associated touch screen display (for the sake of simplicity, the first user interface is not shown in FIG. 15). A second device 1530 shown in FIG. 15 may comprise a second display 1532 showing at least a portion of the second user interface in an active window 1534.

As shown in FIG. 15, the handheld multifunction device 1510 may be movable to alternative positions. A proximate position of the handheld multifunction device 1510 is depicted in solid line in FIG. 15. Alternative distal positions of the handheld multifunction device are depicted in dashed line in FIG. 15.

One or more sensors 1550 may sense presence of the handheld multifunction device 1510 may sense presence of the second device 1530, or may sense proximity of the handheld multifunction device 1510 relative to the second device 1530. As the handheld multifunction device 1510 may be moved by a user through alternative positions, from the distal positions to the proximate position, the handheld multifunction device 1510 may cross a preselected presence or proximity threshold of a presence or proximity recognition component of control logic. Upon crossing such presence or proximity threshold, the presence or proximity recognition component of the control logic may detect the presence or proximity. As shown in FIG. 15, upon detecting the presence or proximity, the second user interface may substantially depict the first device 1515 (e.g., a visual depiction of the handheld multifunction device) in the active window 1534 on the second display 1532. In one embodiment, the visual depiction of the handheld multifunction device in the second user interface is a graphical picture or drawings that closely resembles the appearance of the handheld multifunction device. Further, in one implementation, the first user interface of the handheld multifunction device can be depicted in the visual depiction in the second user interface (e.g., within the depiction of the display of the handheld multifunction device).

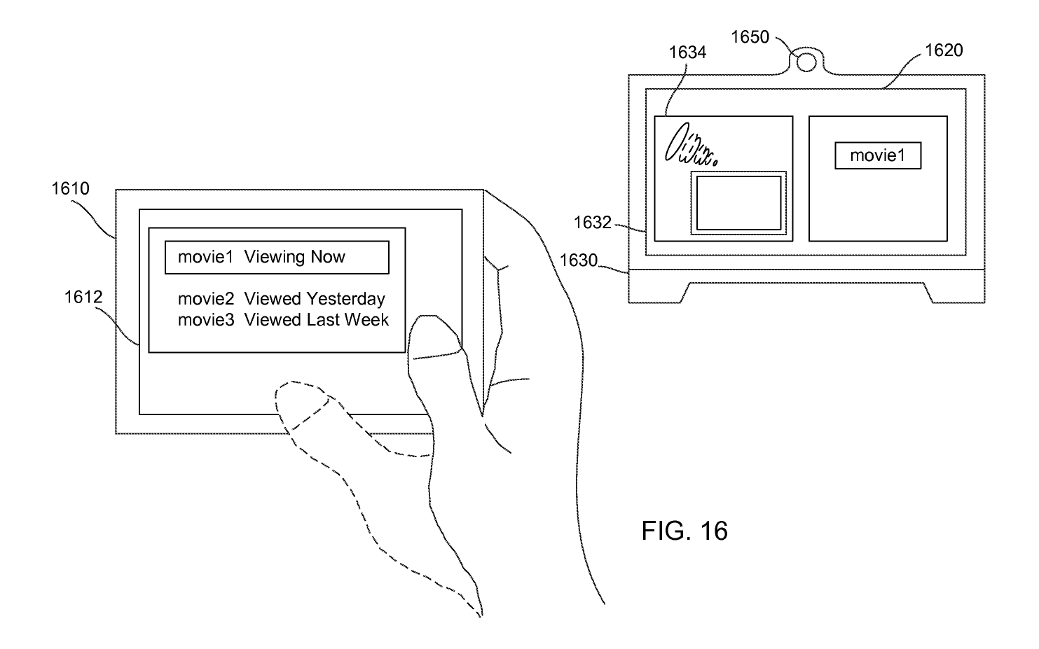

FIG. 16 is a simplified diagram of a second user interface depicting an animation on a second display, substantially contemporaneous with a transfer of media content from a first device to the second device. As shown in FIG. 16, the first device 1610 shown in FIG. 16 may comprise the handheld multifunction device 1610 having an associated touch screen display 1612 showing a first user interface. The second device 1630 shown in FIG. 16 may comprise the second display 1632 showing at least a portion of the second user interface in an active window 1634.

The second user interface may substantially depict the first device (the handheld multifunction device) in the active window 1634 on the second display 1632. Substantially contemporaneous with the transfer of media content from the first device 1610 to the second device 1630, the second user interface may depict animation, for example an animated whirling vortex, which is shown in FIG. 16 as adjacent to the depiction of the first device (the handheld multifunction device) in the active window 1634 on the second display 1632. Additionally, the second user interface may play one or more sounds accompanying the animation.

As shown in FIG. 16, the first user interface may comprise media content shown as listed in an active window of the touch screen display 1612 of the first device 1610. One or more software sensors may be provided to sense media content shown as listed in an active window display of the user interface of the first device. Control logic may be configured for transferring to the second device 1630 the media content shown as listed in the active window display of the first device 1610. For example, the control logic may be configured for transferring to the second device 1630 video content designated by a file name “movie1” in the active window display of the first device 1610. Substantially contemporaneous with such transfer, the file name “movie1” may appear on the display 1632 of the second device 1630, as shown in FIG. 16.

The first user interface may comprise media content shown as selected by a user in a menu display of the first device. For example, as shown in FIG. 16, the first user interface may comprise the video media content designated by the file name “movie1”, which may be highlighted by a box, and which thereby may be shown as selected by the user in a menu (e.g., touch menu) displayed on the first device 1610. Additional menu items designated by the file names “movie2” and “movie3” may also shown in the touch screen menu display of the first device 1610.

One or more software sensors for sensing media content “movie1” selected by the user in the menu displayed on the first device. Control logic may be configured for transferring to the second device 1630 the media content “movie1”, which is shown in FIG. 16 as selected by the user in the menu display of the first device 1610.

The first user interface may comprise media content shown as a recently viewed file in a listing display of the first device. For example, as shown in FIG. 16, the first user interface may comprise the video media content designated by the file name “movie1”, which may be shown as being recently viewed by the legend “Viewing Now” adjacent thereto. Additional menu items designated by the file names “movie2” and “movie3” are also shown in the touch screen menu display of the first device 1610, with adjacent legends “Viewed Yesterday” and “Viewed Last Week”.

One or more software sensors for sensing media content of the recently viewed file “movie1”. The control logic may be configured for transferring to the second device 1630 the media content “movie1”, which is shown in FIG. 16 as the recently viewed file in the listing display of the first device 1610.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that transitioning a media activity, such as presentation of media content, from one device to a different device may be perceived by a user as convenient, intuitive or user-friendly. Another advantage of the invention may be automatic transfer of media activity status from one device to a different device. More particularly, another advantage of the invention may be automatically transfer of status of progress of a one device in playing media content, so that a different device may play the media content according to such progress. Still another advantage of the invention may be automatic media content distribution.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer readable medium including at least computer program code stored therein for presenting media content on a display of another device, said computer readable medium comprising:
computer program code for displaying content on a display of a portable multifunction device;
computer program code for detecting a predefined gesture with respect to the portable multifunction device; and
computer program code for communicating a status of the portable multifunction device to a remote device in response to detection of the predefined gesture with respect to the portable multifunction device.

2. A computer readable medium as recited in claim 1, wherein the content is media content,
wherein the remote device has a remote display,
wherein the status pertains to the content being displayed on the display of the portable multifunction device, and
wherein said computer readable medium comprises:
computer program code for displaying the media content on the remote display in accordance with the status of the portable multifunction device.

3. A computer readable medium as recited in claim 1,
wherein the display is a touch screen display, and
wherein the predefined gesture is with respect to the touch screen display.

4. A computer readable medium as recited in claim 1, wherein said computer readable medium comprises:
computer program code for detecting the remote device being proximate to the portable multifunction device, and
wherein said computer program code for communicating the status of the portable multifunction device to the remote device communicates the status in response to detection of the predefined gesture with respect to the portable multifunction device, provided that the computer code for detecting detects the remote device being proximate to the portable multifunction device.

5. A computer implemented method comprising:
displaying media content on a touch screen display of a portable multifunction device;
communicating a status of the portable multifunction device to a remote device with a remote display; and
displaying the media content on the remote display in response to a predefined gesture on the touch screen display.

6. A computer implemented method as recited in claim 5 further comprising detecting a presence of the remote device or the portable multifunction device, or detecting a proximity of the remote device and the portable multifunction device, wherein the communicating the status comprises communicating the status of the portable multifunction device to the remote device in response to the presence or proximity.

7. A computer implemented method as recited in claim 5 wherein the displaying the media content on the remote display comprises displaying the media content on the remote display in accordance with the status of the portable multifunction device.

8. A computer implemented method as recited in claim 5 wherein:
the communicating the status of the portable multifunction device comprises communicating the status of the portable multifunction device in displaying the media content on the touch screen display; and
the displaying the media content on the remote display comprises displaying the media content on the remote display in accordance with the status of displaying the media content on the touch screen display.

9. A computer implemented method as recited in claim 5 wherein:
the communicating the status of the portable multifunction device comprises communicating a status of progress of the portable multifunction device in playing the media content on the touch screen display; and
the displaying the media content on the remote display comprises playing the media content on the remote display in accordance with the status of progress of the portable multifunction device in playing the media content on the touch screen display.

10. A computer implemented method comprising:
displaying media content on a remote display of a remote device;
communicating a status of the remote device to a portable multifunction device having a touch screen display; and
displaying the media content on the touch screen display in response to a predefined gesture on the touch screen display.

11. A computer implemented method as recited in claim 10 further comprising detecting a presence of the remote device or the portable multifunction device, or detecting a proximity of the remote device and the portable multifunction device, wherein the communicating the status comprises communicating the status of the remote device to the portable multifunction device in response to the presence or proximity.

12. A computer implemented method as recited in claim 10 wherein the displaying the media content comprises displaying the media content on the touch screen display in accordance with the status of the remote device.

13. A computer implemented method as recited in claim 10 wherein:
the communicating the status of the remote device comprises communicating the status of the remote device with respect to display of the media content on the remote display; and
the displaying the media content on the touch screen display comprises displaying the media content on the touch screen display in accordance with the status of the remote device with respect to display of the media content on the remote display.

14. A computer implemented method as recited in claim 10 wherein:
the communicating the status of the remote device comprises communicating a status of progress of the remote device in playing the media content on the remote display; and
the displaying the media content on the touch screen display comprises displaying the media content on the touch screen display in accordance with the status of progress of the remote device in playing the media content on the remote display.

15. A computer implemented method comprising:
providing a first device with a first display, and a second device with a second display;
displaying media content on the first display of the first device;
detecting a presence of the first device or the second device, or detecting a proximity of the first device and the second device;
detecting a predefined gesture of a user; and
displaying the media content on the second display in response to detecting the predefined gesture and detecting the presence or the proximity.

16. A computer implemented method as recited in claim 15 further comprising:
communicating a status of the media content from the first device to the second device; and
displaying the media content on the second display in accordance with the status of the media content from the first device.

17. A computer implemented method as recited in claim 16 wherein:
the communicating the status of the first device comprises communicating a status of progress of the first device in playing the media content on the first display; and
the displaying the media content on the second display comprises playing the media content on the second display in accordance with the status of progress of the first device in playing the media content on the first display.

18. A computer implemented method as recited in claim 15 wherein the detecting the predefined gesture of the user comprises detecting the user touching a touch sensitive surface of the first device or the second device in at least one of:
a predefined swiping touch gesture;
a predefined flicking touch gesture; and
a predefined multi-point touch gesture.

19. A computer implemented method as recited in claim 15 wherein the detecting the predefined gesture of the user comprises detecting the user moving the first device or the second device in at least one of:
a predefined shaking gesture;
a predefined rolling gesture;
a predefined throwing gesture; and
a predefined tapping gesture.

20. A computer readable medium including at least computer program code for managing display of media content on a first device with a first display, and a second device with a second display, said computer readable medium comprising:
computer program code for displaying media content on the first display of the first device;
computer program code for detecting a presence of the first device or the second device, or detecting a proximity of the first device and the second device;
computer program code for detecting a predefined gesture of a user; and
computer program code for displaying the media content on the second display in response to detecting the predefined gesture and detecting the presence or the proximity.

21. A computer system comprising:
a first device hosting media content and having a first display;
a first user interface for controlling display of the media content on the first display;
a second device having a second display;
at least one first sensor for sensing a predefined gesture of a user;
at least one second sensor for sensing a presence of the first device or the second device, or for sensing a proximity of the first device and the second device; and
control logic coupled with the first and second sensors and configured for facilitating display of the media content on the second display in response to detecting the predefined gesture and detecting the presence or the proximity.

22. The computer system as in claim 21 further comprising a second user interface for controlling display of the media content on the second display.

23. The computer system as in claim 21 further comprising a second user interface displaying a depiction of the first device on the second display.

24. The computer system as in claim 21 further comprising a second user interface depicting an animation on the second display, substantially contemporaneous with a transfer of the media content from the first device to the second device.

25. The computer system as in claim 21 wherein the control logic is configured to automatically determine the media content for transfer to the second device and transfer the media content to the second device.

26. The computer system as in claim 21 wherein the control logic is configured to automatically determine whether the media content of the first device is absent on the second device, and to transfer the media content to the second device upon determining that the media content is absent on the second device.

27. The computer system as in claim 21 wherein:
the first user interface comprises the media content shown in an active window display of the first device; and
the control logic is configured to transfer to the second device the media content shown in the active window display of the first device.

28. The computer system as in claim 21 wherein:
the first user interface comprises the media content shown as selected by a user in a menu display of the first device; and
the control logic is configured to transfer to the second device the media content shown as selected by the user in the menu display of the first device.

29. The computer system as in claim 21 wherein:
the first user interface comprises the media content shown as a recently viewed file in a listing display of the first device; and
the control logic is configured to transfer to the second device the media content shown as the recently viewed file in the listing display of the first device.
